(19) United States
(12) Patent Application Publication
(10) Pub. No.: US 2021/0406877 A1
(43) Pub. Date: Dec. 30, 2021

(54) Digital Asset Custody Method and Apparatus and Storage Medium

(71) Applicant: JIANGSU FUZAMEI TECHNOLOGY CO. LTD, HangZhou, Zhejiang (CN)

(72) Inventors: Sijin WU, Suzhou (CN); Zhiwen WANG, Suzhou (CN)

(21) Appl. No.: 17/280,880

(22) PCT Filed: Sep. 12, 2019
(86) PCT No.: PCT/CN2019/105513

§ 371 Date: Mar. 27, 2021

(30) Foreign Application Priority Data
Sep. 29, 2018 (CN) 201811151114.0

(51) Int. Cl. G06Q 20/38; G06Q 40/02; G06Q 20/40; G06Q 20/02; H04L 9/30; G06F 16/27

(52) U.S. Cl. CPC G06Q 20/389; G06Q 40/02; G06Q 20/3829; G06F 16/27; G06Q 20/02; G06Q 20/3825; H04L 9/3073; G06Q 20/4014

(57) ABSTRACT

A digital asset custody method and apparatus, and a storage medium is disclosed. The method includes acquiring identity information of a first user; allocating a first public-private key pair to the first user; encrypting and storing a correspondence between the first public-private key pair and the identity information, generating multiple first addresses on a first blockchain, so as to allow a client of the first user to acquire the same; monitoring whether the client performs transfer to at least one of the first addresses; and if so, performing, on a second blockchain, corresponding token transfer to a second address of the first user according to a currency type and the amount of the transfer. The second address is generated according to a first public key of the first public-private key pair. The method provides a user with a solution in which safe custody of digital assets requires only identity authentication, such that the user is not required to memorize or store private key information or mnemonic information.

### CROSS REFERENCE OF RELATED APPLICATION

This is a U.S. National Stage under 35 U.S.C. 371 of the International Application Number PCT/CN/2019/105513, filed Sep. 12, 2019, which claims priority under 35 U.S.C. 119(a-d) to Chinese application number CN 201811151114.0, filed Sep. 29, 2018.

### BACKGROUND OF THE PRESENT INVENTION

### Field of Invention

The present invention relates to blockchain technology, and more particularly to a digital asset custody (escrow) method, apparatus and storage medium therefor.

### Description of Related Arts

Traditional digital asset managing method is provided for users to manage the account with their own private keys. For example, the user has to memorize the information of the private key or password, or otherwise to remember several one or more mnemonic words corresponding to the private key or to manage own digital asset by inputting the private key information or mnemonic words into a wallet software.

The disadvantage of the above-mentioned digital asset managing method is that once the private key is lost, the digital asset will be permanently gone. The private key information and one or more mnemonic words configured in a fixed order are so difficult for the users to remember that most users need to avoid forgetting the private key by exporting storage, saving screenshots, and recording offline, and so on, which still have the problem of easy loss or steal, that makes digital asset management really inconvenient.

### SUMMARY OF THE PRESENT INVENTION

In view of the shortcomings or disadvantages of the conventional technology, there is a demand for a digital asset custody method, commonly called escrow method, apparatus and storage medium which can provide security to the user without necessary to memorize the private key.

In a first aspect, the present invention provides a digital asset escrow method, adapted for an escrow server, comprising the steps of:

obtaining an identity information of a first user;

allocating a first pair of public-private keys to the first user, encrypting and storing the corresponding relationship between the first pair of public-private keys and the identity information;

generating a plurality of first addresses on a first blockchain for obtaining by a client of the first user;

respectively synchronizing data of the first blockchain to monitor whether the client transfers to at least one of the first addresses:

if so, performing a token transfer on a second blockchain to a second address of the first user correspondingly, according to a currency and an amount of the token transfer.

In which, the second address is generated according to the first public key of the first pair of public-private keys.

In a second aspect, the present invention provides a digital asset escrow method, adapted for a client, comprising the steps of:

providing an identity authentication, submitting an identity information of a current user an escrow server, for allocating a first pair of public-private keys for the current user, and encrypting and storing a corresponding relationship between the first pair of public-private keys and the identity information;

obtaining a plurality of first addresses on a first blockchain from the escrow server;

transferring tokens to at least one of the plurality of first addresses, so that when the escrow server monitors a transfer by respectively synchronizing data of the first blockchain, according to a currency and an amount of the transfer, the token transfer is performed on a second blockchain to a second address of the current user correspondingly.

In which, the second address is generated according to a first public key of the first pair of public-private keys.

In a third aspect, the present invention provides an apparatus, comprising one or more processors and a memory, wherein the memory comprises executable instructions for the one or more processors, so as to execute the digital asset escrow method, provided by one or more embodiments according to the present invention, by the one or more processors.

In a fourth aspect, the present invention provides a storage medium storing a computer program which enables a computer to execute the digital asset escrow method provided by one or more embodiments according to the present invention.

According to one or more embodiments of the present invention, a digital asset escrow method, and an apparatus and a storage medium therefor are provided, which can authenticate the user's identity, escrow the user's private key corresponding to the user's identity, and allocate corresponding tokens on the second blockchain according to the digital asset escrowed by the user on the first blockchain, thus providing a solution for the user to escrow digital asset with security only required identity authentication without requiring to memorize or save private key information or mnemonic information.

In some embodiments of the present invention, a digital asset escrow method, and an apparatus and a storage medium therefor are provided, which can further freeze the tokens on the second address according to the user's request after passing the user's identity authentication, thereby ensuring security of the user's digital asset in the case of possible loss of the private key.

In some embodiments of the present invention, a digital asset escrow method, and an apparatus and a storage medium therefor are provided, which can reallocate the first pair of public-private keys and the second address according to the user's request after the user's identity authentication, and the tokens on the original second address is transferred to the new second address, thereby ensuring security of the user's digital asset in the case of possible loss of or forgot the private key.

In some embodiments of the present invention, a digital asset escrow method, and an apparatus and a storage medium therefor are provided, which can facilitate the user's digital asset configuration and transaction by directly preforming the transfer or transfer group of the token on the second blockchain by the client.

### BRIEF DESCRIPTION OF THE DRAWINGS

In order to distinctly illustrate the features, purposes and advantages in the non-limiting embodiments of the present invention, the drawings will be briefly described below.

FIG. 1 is a schematic view according to an embodiment of the present invention, illustrating the escrow for the digital asset.

FIG. 2 is a flowchart of a digital asset escrow method according to an embodiment of the present invention.

FIG. 3 is a flowchart of the method according to the above embodiment of the present invention, illustrated a preferred mode in FIG. 2 .

FIG. 4 is a flowchart of the method according to the above embodiment of the present invention, illustrated a preferred mode in FIG. 2 .

FIG. 5 is a flowchart of the method according to the above embodiment of the present invention, illustrated a preferred mode in FIG. 2 .

FIG. 6 is a flowchart of a digital asset escrow method according to another embodiment of the present invention.

FIG. 7 is a flowchart of the method according to the above another embodiment of the present invention, illustrated a preferred mode in FIG. 6 .

FIG. 8 is a flowchart of the method according to the above another embodiment of the present invention, illustrated a preferred mode in FIG. 6 .

FIG. 9 is a flowchart of the method according to the above another embodiment of the present invention, illustrated a preferred mode in FIG. 6 .

FIG. 10 is a flowchart of the method according to the above another embodiment of the present invention, illustrated a preferred mode in FIG. 6 .

FIG. 11 is a structural schematic view of an apparatus according to an embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art.

The general principles defined in the following description would be applied to other embodiments, alternatives, modifications, equivalents, and applications without departing from the spirit and scope of the present invention.

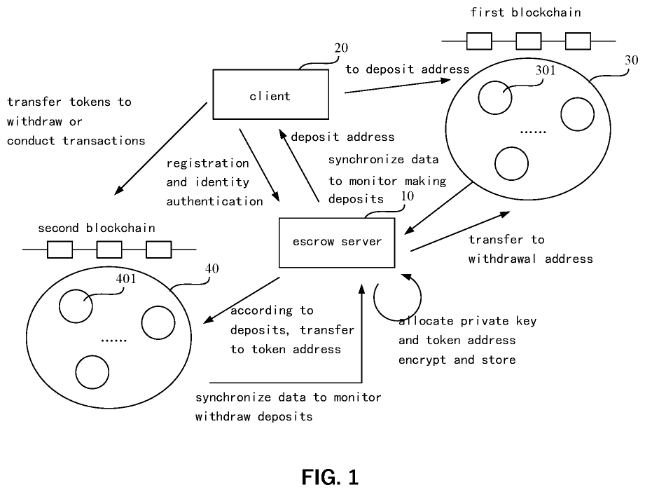

FIG. 1 is a schematic view illustrating a scene of the escrow for the digital asset according to an embodiment of the present invention. As shown in FIG. 1, the present invention provides an escrow solution for digital asset.

After a user A has processed a registration and an identity authentication via a client 20, an escrow server 10 allocates a first pair of public-private keys for the user A to configure and manage token asset on a second blockchain, and a second pair of public-private keys for token depositing. The escrow server 10 can encrypt and store an identity information of the user and the first pair of public-private keys in at least one of the following locations: the escrow server locally, a cloud server, or any blockchain.

The escrow server 10 generates a token address R_{Z} on the second blockchain according to a first public key of the first pair of public-private keys, and generates a plurality of deposit addresses respectively on a first blockchain, such as the deposit address R_{A} on the XXA chain, the deposit address R_{B} on the XXB chain, and the deposit address R_{C} on the XXC chain, etc., according to a second public key of the second pair of public-private keys for the user A.

When the user A wants to escrow 100 XXA tokens , the client 20 can obtain the deposit address R_{A} from the escrow server 10, and transfer 100 XXA tokens to the deposit address R_{A} on the first blockchain.

The escrow server 10 monitors whether each user is depositing tokens by continuously synchronizing data of each first blockchain. When it is monitored that the user A has transferred 100 XXA tokens to the deposit address R_{A}, the token address R_{Z} of the user on the second blockchain is transferred with 100 YYY_XXA tokens. Similarly, when it is monitored that the user A has transferred 100 XXC tokens to the deposit address R_{c}, the token address R_{Z} of the user on the second blockchain is transferred with 100 YYY_XXC tokens, and etc.. The above-mentioned tokens can be used as corresponding digital asset on the second blockchain YYY. For example, YYY_XXA tokens can be regarded as XXA tokens on the second blockchain YYY, and YYY_XXC tokens can be regarded as XXC tokens on the second blockchain YYY.

The client 20 of the user A can obtain the first private key from the escrow server 10, thereby confirming whether the transferred token is received by synchronizing the data of the second blockchain.

After receiving the tokens, the user A can choose to withdraw, pay, or directly conduct token transactions with other users on the second blockchain according to his or her own needs, and so on.

For example, when the user A needs to pay 30 XXA tokens to a user B, for example a merchant, on a XXA chain of the first blockchain, after obtaining the authentication information from the user B, the client 20 sends the above authentication information and the withdrawal request for a receiving address of the user B on the XXA chain to the escrow server 10, and that 30 YYY_XXA tokens are transferred to a token retrieving address on the second blockchain.

After receiving the withdrawal request, the escrow server 10 monitors the token retrieving address whether the 30 YYY_XXA tokens transferred by the user A by synchronizing the data of the second blockchain has been received. After confirming the receipt, the 30 XXA tokens are transferred to the receiving address of the user B on the XXA chain, and the authentication information is a postscript information of the transfer, so that the user A and the user B can both confirm the payment by synchronizing the data of the XXA chain.

Also, for example, when the user A needs to pay 5 XXB tokens to merchant C on XXB chain of the first blockchain, but the user A currently does not have YYY_XXB tokens, the user A can use the YYY_XXA tokens or YYY_XXC tokens he or she hold to make a transaction with the user D in exchange for YYY_XXB tokens, and then pay the merchant C through the above method.

In the above solution, since the first private key is managed by the escrow server 10, the user does not need to worry about forgetting the private key. When the user loses the private key due to reinstallation of the APP, replacement of the mobile phone, loss of the mobile phone, etc., the user only needs to pass the identity authentication and the first private key can be retrieved from the escrow server 10 without memorizing or saving the private key information or mnemonic word information.

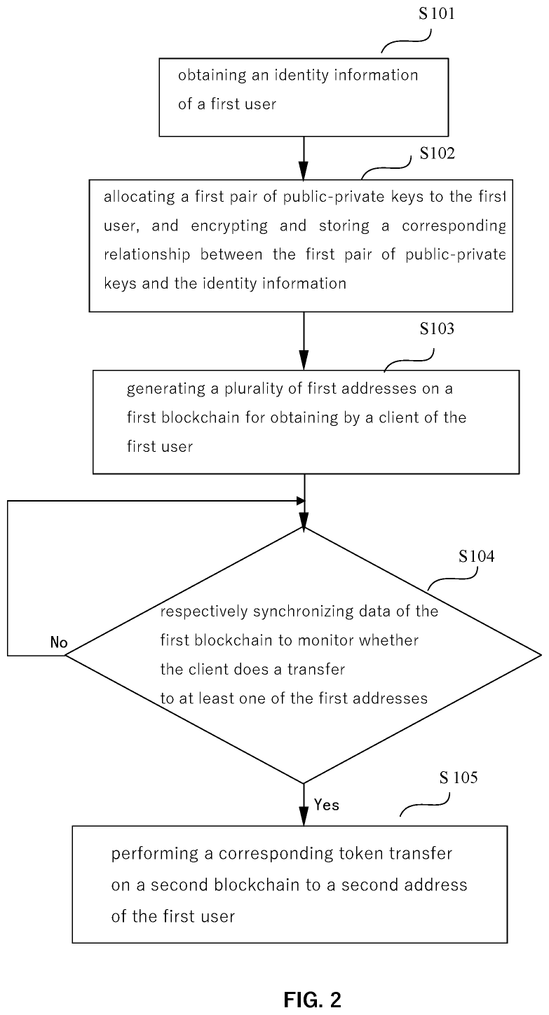

The above-mentioned solution as shown in FIG. 1 is only an embodiment, and various solutions and principles provided by the present invention are described in detail below referring to FIGS. 2-11.

FIG. 2 is a flowchart of a digital asset escrow method according to an embodiment of the present invention.

As shown in FIG. 2, in this embodiment, the present invention provides the digital asset escrow method adapted for the escrow server, comprising:

S101: obtaining the identity information of the first user;

S102: allocating the first pair of public-private keys to the first user, and encrypting and storing a corresponding relationship between the first pair of public-private keys and the identity information;

S103: generating a plurality of first addresses on the first blockchain for obtaining by the client of the first user;

S104: respectively synchronizing data of the first blockchain to monitor whether the client does a transfer to at least one of the plurality of first addresses; and

S105: if yes, according to a currency and an amount of the transfer, performing a corresponding token transfer on the second blockchain with respect to the second address of the first user.

In which, the second address is generated according to the first public key of the first pair of public-private keys.

Specifically, in this embodiment, the user needs to have identity authentication when registering, and the identity information of the user is collected through the client, such as any one or more of the following: face image, pupil image, fingerprint information, ID card image, image of holding the designated information in user's hand, voiceprint information, etc., and send the identity information to the escrow server.

In the step S101, after the escrow server receives the identity information, the user's identity is authenticated according to the identity information, and if the authentication fails, the client is notified that the identity information needs to be resubmitted.

In another embodiment, the client may directly perform identity authentication, and after the authentication succeeds, the identity information is sent to the escrow server 10.

In another embodiment, it is not mandatory to require identity authentication when registering, and it is required whether the user has been authenticated before the user make the deposits. If the identity authentication has not been performed, the deposits must be made after the authentication is completed.

In step S102, the escrow server allocates a first pair of public-private keys for the user to configure and manage account of token assets on the second blockchain. Specifically, in this embodiment, the first pair of public-private keys is generated based on the UID assigned to the user, and the second address is generated based on the first public key in the first pair of public-private keys. In other embodiments, it can also be based on other parameters of the user to generate the first pair of public-private keys and the second address, or randomly generate the first pair of public-private keys and the second address, and so on.

In step S103, the escrow server randomly generates a second pair of public-private keys for the user to deposit tokens on the first blockchain, and generates the second public key in each of the second pair of public-private keys for the user. The first address for depositing tokens on the first blockchain. When a user wants to deposit a plurality of certain cryptocurrencies, the user can obtain the corresponding first address from the escrow server through the client, and the corresponding tokens to the first address on the first blockchain is transferred to deposit tokens . In another embodiment, it is also possible to configure the first address of all users on the first blockchain as the same one address; however the user is required to add designated identification information when depositing or withdraw tokens. For example, any one or more pieces of information, such as additional user name, user ID , and authentication code, can be used as designated identification information for the escrow server to identify the user who deposits the token.

In step S104, the escrow server can monitor whether the user is depositing tokens by synchronizing each of the data of the first blockchain. For example, for the first blockchain of the account system, the first address can be monitored by synchronizing the data whether the balance has increased. For the first blockchain of the UTXO system, whether the first address receives UTXO can be monitored through synchronization data, and so on.

In step S105, when the deposit is detected, the corresponding currency and amount of tokens can be transferred to the second address of the user on the second blockchain according to the currency and amount. Specifically, the escrow server can transfer tokens to the second address through the escrow account configured on the second blockchain. It can also send a transaction configured with token currency parameters and amount parameters to trigger the contract configured on the second blockchain node, and after the contract verifies the transaction, the token transfer is automatically performed to the second address according to the token currency parameter and the amount parameter.

After completing the token transfer, the user can synchronize the data of the second blockchain through the client to confirm receipt of the transferred token, thereby completing the escrow of the digital asset.

By authenticating the identity of the user, according to the above embodiments, the private key corresponding to the identity is escrowed for the user, and the corresponding tokens on the second blockchain is allocated according to each of the digital assets that the user has escrowed on the first blockchain, so as to provide a solution that can guarantee the security of digital asset escrow only by passing identity authentication, without having to memorize or save private key information or mnemonic information for the user.

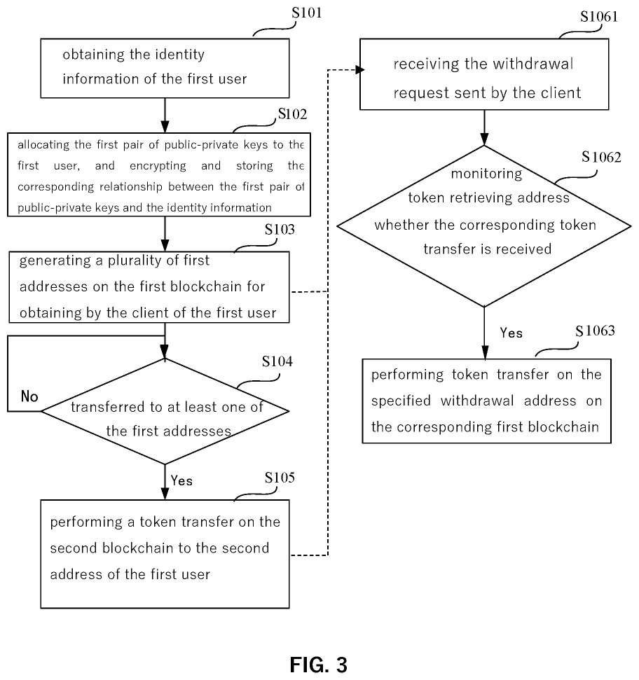

FIG. 3 is a flowchart of a preferred mode of the method illustrated in FIG. 2 according to the above embodiment of the present invention. As shown in FIG. 3, in a preferred embodiment, the above method further comprises:

S1061: receiving a withdrawal request sent by the client;

S1062: according to the withdrawal request, monitoring whether the token retrieving address on the second blockchain receives the corresponding token transfer from the client; and

S1063: if yes, according to the withdrawal request, performing a token transfer to a specified withdrawal address on the corresponding first blockchain.

Specifically, the user can transfer the digital asset under escrow to other wallets by configuring parameters such as the withdrawal address and the postscript information, or directly use the digital asset under escrow for payment.

When the user wants to transfer the digital asset under escrow to his or her other wallet, the user can configure the withdrawal address in the withdrawal request as the address of the wallet. And when the user wants to make a payment directly, the user can configure the withdrawal address as the address provided by the payee, and the postscript information is configured as the identification and authentication information specified by the payee, such as the authentication code or the order number of the paid order.

In the step S1061, the escrow server receives the withdrawal request generated and sent by the client.

In this embodiment, after the client is configured to generate the withdrawal request and send to the escrow server, the client can obtain the token retrieving address from the escrow server and, according to the withdrawal request, transfer the corresponding tokens to the token retrieving address from the second address on the second blockchain. In another embodiment, the escrow server can also perform the corresponding transfer from the second address to the token retrieving address after receiving the withdrawal request according to the withdrawal request.

In the step S1062, according to the above withdrawal request, the escrow server monitors the token retrieving address for whether the corresponding currency and number of tokens transferred from the second address is received by synchronizing the data of the second blockchain:

If yes, the step S1063 is executed to transfer tokens to the designated withdrawal address on the corresponding first blockchain according to the withdrawal request, so as to complete the transfer or payment of digital asset.

Preferably, the step S1061 further comprises: receiving a withdrawal request sent by the client, and judging the withdrawal request whether the identity authentication is triggered according to a pre-configured security contract.

If yes, an authentication notification is sent to the client, so that the client can collect and return the first identity authentication information after receiving the authentication notification, and verify the first identity authentication information.

Specifically, the security contract can also be configured on the client or the escrow server. For example, when a user withdraws more than a predetermined amount configured in the security contract, the identity authentication is required to be verified, or every time a user withdraws tokens, configured in the security contract, identity authentication is required to be verified, and so on. The verification can be directly performed locally on the client, or the identity authentication information can be collected by the client and sent to the escrow server for verification.

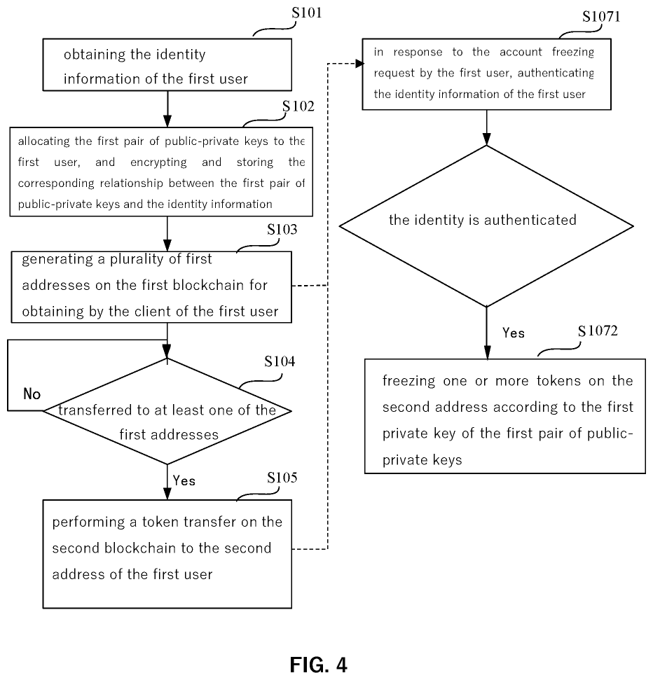

FIG. 4 is a flowchart of a preferred mode of the method as illustrated in FIG. 2 according to the above embodiment of the present invention. As shown in FIG. 4, in a preferred embodiment, the above method further comprises:

S1071: in response to the account freezing request by the first user, authenticating the identity of the first user; and

S1072: if the identity is authenticated, freezing one or more tokens on the second address according to the first private key of the first pair of public-private keys.

Specifically, when a mobile phone is lost, or an account is suspected of being stolen, the user can send an account freezing request and have an identity authentication immediately. After verifying the user's identity, the escrow server sends a contract signed by the first private key to trigger the corresponding transaction to a node of the second blockchain, thereby freezing the tokens on the second address. After the security warming is removed, the user can send an unfreeze request and perform identity authentication. After verifying the identity, the escrow server also sends a contract signed by the first private key to trigger the corresponding transaction to the node of the second blockchain, thereby unfreezing the tokens on the second address.

The method of the above embodiment further freezes the tokens on the second address according to the user's request after the user's identity authentication, thereby ensuring the security of the user's digital asset when the private key is lost.

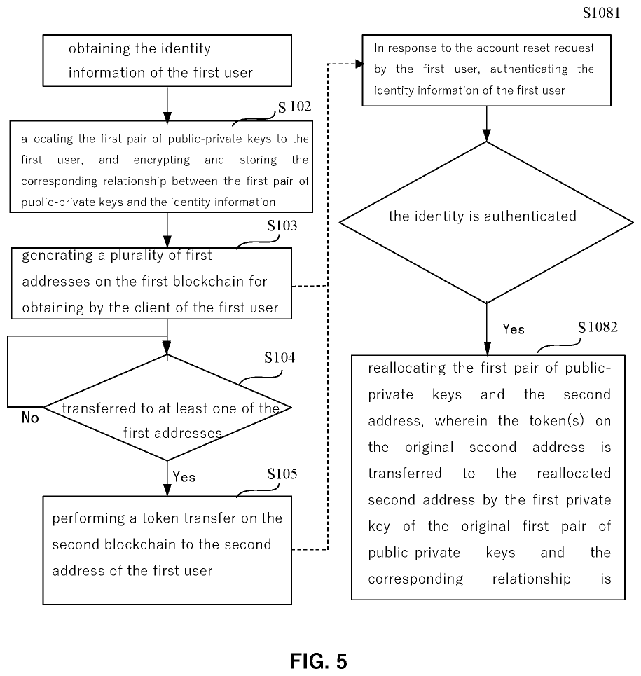

FIG. 5 is a flowchart of a preferred mode of the method illustrated in FIG. 2 according to the above embodiment of the present invention. As shown in FIG. 5, in a preferred embodiment, the above method further comprises:

S1081: in response to the account reset request by the first user, authenticating the identity of the first user; and

S1082: if the identity is authenticated, reallocating the first pair of public-private keys and the second address, wherein the tokens on the original second address is transferred to the reallocated second address by the first private key of the original first pair of public-private keys and the corresponding relationship is updated.

Specifically, when the security warming happens, the user can also send an account reset request and perform the identity authentication. The escrow server reallocates the first pair of public-private keys and the second address for the user after the identity authenticating of the user, and transfers the token asset on the original second address to the newly generated second address. The transfer of token asset can be made through the original first private key signature transfer transaction, or automatically through the contract triggered by the original first private key signature transaction and configured on the second blockchain node.

The method of the above embodiment further reallocates the first pair of public-private keys and the second address according to the user's request after authenticating the identity of the user, and transfers the tokens from the original second address to the new second address, thereby ensuring the security of the user's digital asset when the private key is lost.

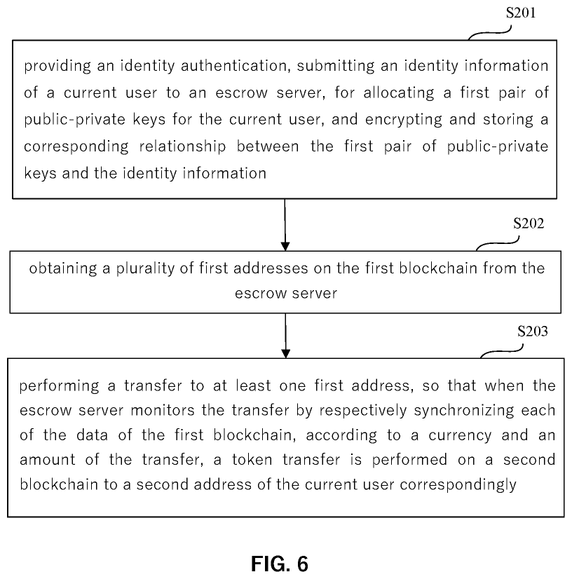

FIG. 6 is a flowchart of a digital asset escrow method according to another embodiment of the present invention. The method shown in FIG. 6 can be executed with the method shown in FIG. 2.

As shown in FIG. 6, in this embodiment, the present invention also provides a digital asset escrow method adapted for the client, comprising:

S201: providing an identity authentication, submitting the current user's identity information to the escrow server, for allocating the first pair of public-private keys for the current user, and encrypting and storing the corresponding relationship between the first pair of public-private keys and the identity information;

S202: obtaining a plurality of first addresses on the first blockchain from the escrow server; and

S203: performing a transfer to at least one of the plurality of first addresses, so that when the escrow server monitors the transfer by respectively synchronizing each of the data of the first blockchain, according to a currency and an amount of the transfer, a token transfer is performed on a second blockchain to a second address of the current user correspondingly.

In which, the second address is generated according to a first public key of the first pair of public-private keys.

Specifically, the digital asset escrow principle of the method as shown in FIG. 6 can refer to the method as illustrated in FIG. 2, which will not be repeated.

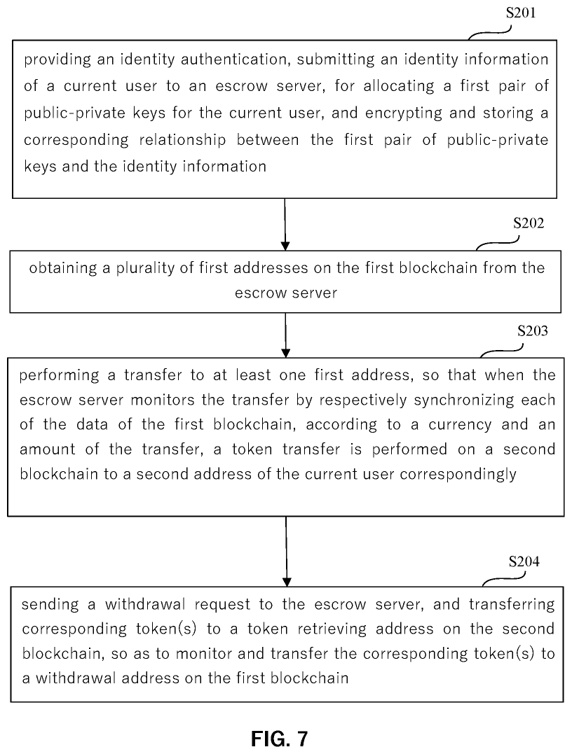

FIG. 7 is a flowchart of a preferred mode of the method as illustrated in FIG. 6 according to the above embodiment of the present invention. The method shown in FIG. 7 can be executed with the method shown in FIG. 3.

As shown in FIG. 7, in a preferred embodiment, the above method further comprises:

S204: sending a withdrawal request to the escrow server, and transferring the token to the token retrieving address on the second blockchain, so that the escrow server, after receiving the withdrawal request, can monitor whether the token retrieving address receives the transfer of the one or more corresponding tokens, and can transfer the tokens to the withdrawal address specified by the withdrawal request on the first blockchain while the token retrieving address has received the corresponding token.

In a preferred embodiment, the step of sending the withdrawal request to the escrow server further comprises: sending the withdrawal request to the escrow server, so that the escrow server can determine whether the identity authentication according to a pre-configured security contract is triggered, and return the authentication notice when triggered; and

after receiving the authentication notice, the first identity information is collected and sent to the escrow server for authentication.

In another preferred embodiment, the step of sending the withdrawal request to the escrow server further comprises: generating a withdrawal request, to determine whether identity authentication is triggered according to a pre-configured security contract: if so, collect the second identity information for authentication; and

when the identity is authenticated, the withdrawal request is sent to the escrow server.

The principle of withdrawal method as shown in FIG. 7 can refer to the method as shown in FIG. 3, which will not be repeated.

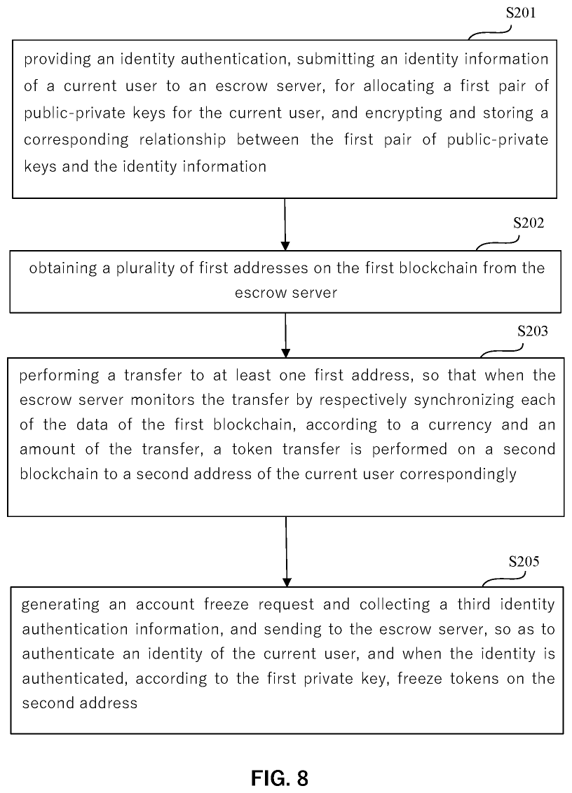

FIG. 8 is a flowchart of a preferred mode of the method illustrated in FIG. 6 according to the above embodiment of the present invention. The method shown in FIG. 8 can be executed with the method shown in FIG. 4.

As shown in FIG. 8, in a preferred embodiment, the above method further comprises:

S205: generating an account freeze request and collecting a third identity authentication information, and sending the account freeze request and the third identity authentication information to the escrow server, so that the escrow server can authenticate the identity of the current user, and when the identity is authenticated, according to the first private key of the first pair of public-private keys, freeze one or more tokens on the second address.

The principle of account freezing of the method shown in FIG. 8 can refer to the method shown in FIG. 4, which will not be repeated.

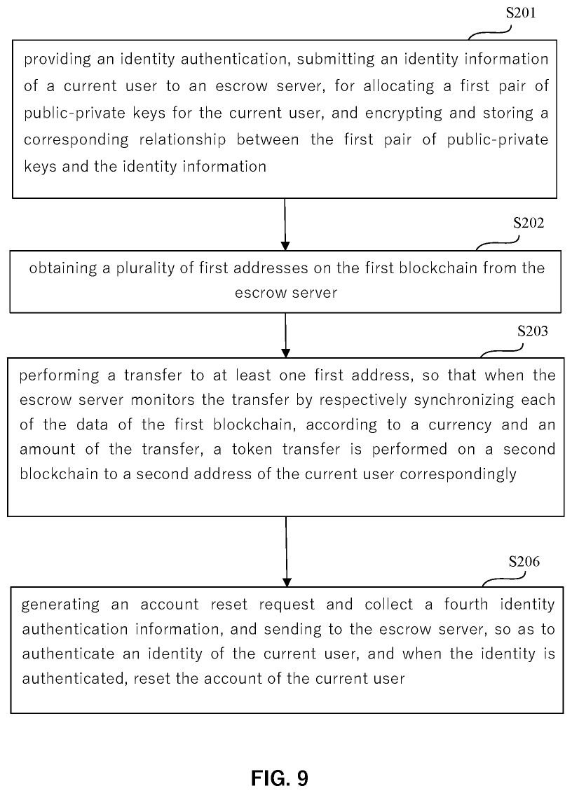

FIG. 9 is a flowchart of a preferred mode of the method illustrated in FIG. 6 according to the above embodiment of the present invention. The method shown in FIG. 9 can be executed with the method shown in FIG. 5.

As shown in FIG. 9, in a preferred embodiment, the above method further comprises:

S206: generating an account reset request and collecting a fourth identity authentication information, and sending the account reset request and the fourth identity authentication information to the escrow server, so that the escrow server can authenticate the identity of the current user, and when the identity is authenticated, reallocate the first pair of public-private keys and the second address, wherein one or more tokens on the original second address is transferred to the reallocated second address by the first private key of the original first pair of public-private keys and the corresponding relationship is updated.

The principle of account resetting of the method shown in FIG. 9 can refer to the method shown in FIG. 5, which will not be repeated.

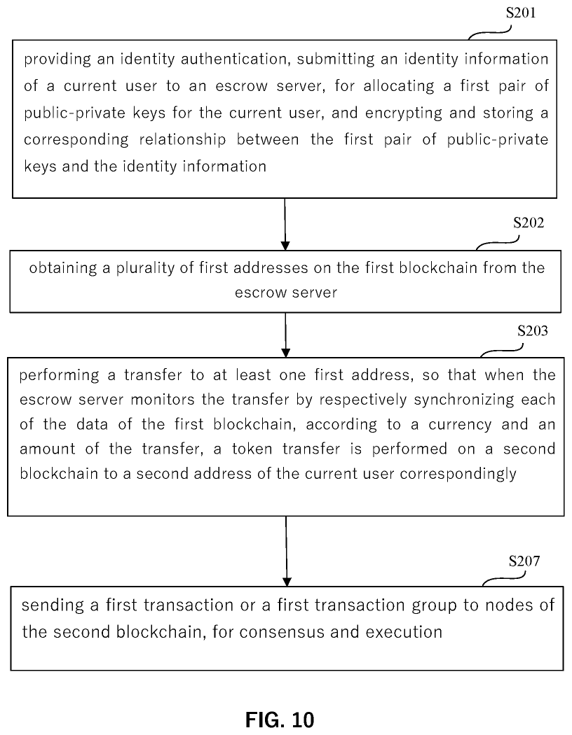

FIG. 10 is a flowchart of a preferred mode of the method illustrated in FIG. 6 according to the above embodiment of the present invention. The method shown in FIG. 10 can be executed with any of the methods shown in FIGS. 2-5.

As shown in FIG. 10, in a preferred embodiment, the above method further comprises:

S207: sending the first transaction or the first transaction group to one or more nodes of the second blockchain, for consensus and execution.

The first transaction group comprises a first transaction and a second transaction. The first transaction transfers one or more tokens from the second address to the third address on the second blockchain, and the second transaction transfers one or more tokens from the third address to the second address.

Specifically, users can also directly conduct token asset transactions with other users or merchants on the second blockchain. The token asset transaction can be directly conduct by the client through the signed first private key to send transactions or transaction groups to the nodes of the second blockchain without through the escrow server.

Preferably, in order to ensure the security of digital asset of the escrow account, the client can also configure a security contract for token transactions, such as, a payment password is required to be entered, identity authentication is required through the escrow server if a certain amount is over, and so on.

Preferably, also, in order to ensure the security of the digital asset of the escrow account, the first transaction or the first transaction group can further be configured to be executed by multi-signature of the transaction parties and the escrow server. One skilled in the art can know the specific principle of multi-signature, which will not be repeated here.

The foregoing embodiments further facilitates the configuration and transaction of digital asset of the clients by directly conducting transactions or transaction groups of tokens on the second blockchain.

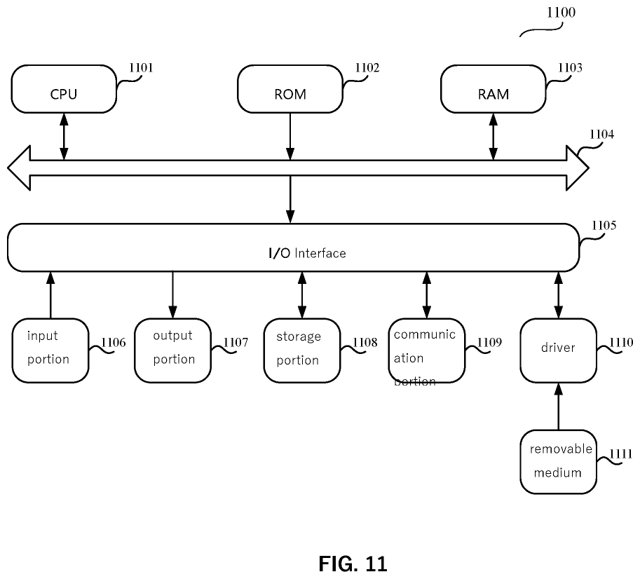

FIG. 11 is a structural schematic view of an apparatus according to another embodiment of the present invention.

As shown in FIG. 11, as another aspect, the present invention also provides an apparatus 1100 comprising one or more central processing units (CPU) 1101, a read-only memory (ROM) 1102, a random access memory (RAM) 1103 and a storage portion 1108, wherein the central processing units (CPU) 1101 can be based on a program stored in the read-only memory (ROM) 1102 or a program loaded from the storage portion 1108 into the random access memory (RAM) 1103 to execute various appropriate movements and processes. In the RAM 1103, various programs and data required for the operation of the apparatus 1100 are also stored therein. The CPU 1101, the ROM 1102, and the RAM 1103 are connected with each other through a bus 1104. An input/output (I/O) interface 1105 is also connected to the bus 1104.

The apparatus 1100 further comprises following components connected to the I/O interface 1105: an input portion 1106 comprising a keyboard, a mouse, and etc.; an output portion 1107 comprising a cathode ray tube (CRT), a liquid crystal display (LCD), and speakers, and etc.; a storage portion 1108 comprising a hard disk, and etc.; a communication portion 1109 comprising a network interface card, such as a LAN card, a modem, and the like. The communication portion 1109 is functional as communication processing via a network such as the Internet. The apparatus 1100 further comprises a driver 1110 is also connected to the I/O interface 1105, as needed. The apparatus 1100 further comprises a removable medium 1111, such as a magnetic disk, an optical disk, a magneto-optical disk, a semiconductor memory, etc., installed on the drive 1110 as needed, so that the computer program read therefrom is installed into the storage portion 1108 as needed.

In particular, according to the embodiments of the present invention, the digital asset escrow method disclosed in each of the above embodiments can be implemented as a computer software program. For example, one embodiment of the present invention as disclosed is implemented as a computer program product, which comprises a computer program tangibly embodied on a mechanical readable medium, and the computer program comprises several program codes for executing a digital asset escrow method.

In such embodiment, the computer program may be downloaded and installed from the network through the communication portion 1109, and/or installed from the removable medium 1111.

As another aspect, the present invention also provides a computer readable storage medium. The computer readable storage medium may be the computer readable storage medium comprised in the apparatus of the above-mentioned embodiment or may be dependent device unmounted from the apparatus. The computer readable storage medium is stored with one or more programs, and the one or more programs are used by one or more processors to execute the digital asset escrow method disclosed in the present invention.

The flowcharts and block diagrams in the drawings illustrate possible implementation architecture, functions, and operations of the system, method, and computer program product according to the embodiments of the present invention. In this regard, each block in the flowchart or block diagram may represent a module, a program segment, or part of codes, and the module, the program segment, or the part of code comprise one or more for realizing the specified executable logic instructions. It should also be noted that, in some alternative modes, the functions marked in the block may also be executable in a different order from the order marked in the drawings. For example, two blocks shown in succession can actually be executed substantially in parallel, and they can sometimes be executed in the reverse order, depending on the functions. It should also be noted that each block in the block diagram and/or flowchart, and the combination of the blocks in the block diagram and/or flowchart, can be implemented by a dedicated hardware-based system that performs the specified functions or operations or can be realized by a combination of dedicated hardware and computer instructions.

The units or modules involved in the embodiments described in the present invention can be implemented in software or hardware. The described units or modules may also be arranged in the processor. For example, each of the described units may be a software program arranged in a computer or a mobile smart device, or may be an independent configured hardware device. The names of these units or modules do not constitute a limitation on the units or modules themselves under certain circumstances.

The above description is only a preferred embodiment of the present invention and an explanation of the applied technical principles. One skilled in the art should understand that the scope of the invention involved in this invention is not limited to the technical solutions formed by the specific combination of the above technical features, and should also cover other technical solutions formed by arbitrarily combining the equivalent features without departing from the concept of the invention. For example, the above-mentioned features and the technical features disclosed in this invention (but not limited to) with similar functions are mutually replaced to form a technical solution. One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention comprises all modifications encompassed within the spirit and scope of the following claims.

1-16. (canceled)

17. A digital asset escrow method, comprising steps of:
obtaining an identity information of a first user;
allocating a first pair of public-private keys to said first user, and encrypting and storing a corresponding relationship between said first pair of public-private keys and said identity information;
generating a plurality of first addresses on a first blockchain for obtaining by a client of said first user;
respectively synchronizing data of said first blockchain to monitor whether said client does a transfer to at least one of said plurality of first addresses; and
if yes, according to a currency and an amount of said transfer, performing a corresponding token transfer on a second blockchain to a second address of said first user, wherein said second address is generated based on a first public key of said first pair of public-private keys.

18. The digital asset escrow method, as recited in claim 17, further comprising steps of:
receiving a withdrawal request sent by said client;
according to said withdrawal request, monitoring whether a token retrieving address on said second blockchain receives said corresponding token transfer of said second address; and
if yes, according to said withdrawal request, performing a transfer to a specified withdrawal address on said first blockchain correspondingly.

19. The digital asset escrow method, as recited in claim 18, wherein the step of receiving a withdrawal request sent by said client further comprises:
receiving said withdrawal request sent by said client, and determining whether said withdrawal request triggers an identity authentication according to a pre-configured security contract;
if yes, sending an authentication notification to said client, so that said client collects and returns a first identity authentication information after receiving said authentication notification; and
authenticating said first identity information.

20. The digital asset escrow method, as recited in claim 17, further comprising the steps of:
in response to an account freezing request by said first user, authenticating said identity information of said first user; and
if said identity information is authenticated, freezing one or more tokens on said second address according to said first private key of said first pair of public-private keys.

21. The digital asset escrow method, as recited in claim 19, further comprising the steps of:
in response to an account freezing request by said first user, authenticating said identity information of said first user; and
if said identity information is authenticated, freezing one or more tokens on said second address according to said first private key of said first pair of public-private keys.

22. The digital asset escrow method, as recited in claim 17, further comprising the steps of:
in response to an account reset request by said first user, authenticating said identity information of said first user; and
if said identity information is authenticated, reallocating said first pair of public-private keys and said second address, wherein one or more tokens on said original second address is transferred to said reallocated second address by said first private key of said original first pair of public-private keys and said corresponding relationship is updated.

23. The digital asset escrow method, as recited in claim 19, further comprising the steps of:
in response to an account reset request by said first user, authenticating said identity information of said first user; and
if said identity information is authenticated, reallocating said first pair of public-private keys and said second address, wherein one or more tokens on said original second address is transferred to said reallocated second address by said first private key of said original first pair of public-private keys and said corresponding relationship is updated.

24. The digital asset escrow method, as recited in claim 17, wherein the step of generating a plurality of first addresses on a first blockchain for a client of said first user to obtain further comprises:
generating a second pair of public-private keys randomly for said first user; and
according to a second public key of said second pair of public-private keys, generating said first addresses on said first blockchain for said client to obtain.

25. The digital asset escrow method, as recited in claim 19, wherein the step of generating a plurality of first addresses on a first blockchain for a client of said first user to obtain further comprises:
generating a second pair of public-private keys randomly for said first user; and
according to a second public key of said second pair of public-private keys, generating said first addresses on said first blockchain for said client to obtain.

26. A digital asset escrow method, comprising the steps of:
providing an identity authentication, submitting an identity information of a current user to an escrow server, for allocating a first pair of public-private keys for said current user, and encrypting and storing a corresponding relationship between said first pair of public-private keys and said identity information;
obtaining a plurality of first addresses on a first blockchain from said escrow server;
preforming a transfer to at least one of said plurality of first address, so that when said escrow server monitors the transfer by respectively synchronizing data of said first blockchain, according to a currency and an amount of the transfer, a token transfer is performed on a second blockchain to a second address of said current user correspondingly.

27. The digital asset escrow method, as recited in claim 26, further comprising a step of:
sending a withdrawal request to said escrow server, and transferring one or more corresponding tokens to a token retrieving address on said second blockchain, so that said escrow server, after receiving said withdrawal request, monitors whether said retrieving address receives said transfer of the one or more corresponding tokens, and when monitored said transfer being received, transfers to a withdrawal address specified by said withdrawal request on said first blockchain according to said withdrawal request.

28. The digital asset escrow method, as recited in claim 27, wherein the step of sending a withdrawal request to said escrow server further comprises:
sending said withdrawal request to said escrow server, so that said escrow server determines whether triggers said identity authentication according to a pre-configured security contract and returns an authentication notice when triggered; and
after receiving said authentication notice, collecting a first identity information to send to said escrow server for authentication.

29. The digital asset escrow method, as recited in claim 27, wherein the step of sending a withdrawal request to said escrow server further comprises:
generating said withdrawal request, and determining whether triggers said identity authentication according to a pre-configured security contract;
if yes, collecting a second identity information for authentication; and
when said identity is authenticated, sending said withdrawal request to said escrow server.

30. The digital asset escrow method, as recited in claim 26, further comprising the steps of:
generating an account freeze request and collecting a third identity authentication information, and sending said account freeze request and said third identity authentication information to said escrow server, so that said escrow server authenticates an identity of said current user, and when said identity is authenticated, according to said first private key of said first pair of public-private keys, freezes one or more tokens on said second address.

31. The digital asset escrow method, as recited in claim 28, further comprising the steps of:
generating an account freeze request and collecting a third identity authentication information, and sending said account freeze request and said third identity authentication information to said escrow server, so that said escrow server authenticates an identity of said current user, and when said identity is authenticated, according to said first private key of said first pair of public-private keys, freezes one or more tokens on said second address.

32. The digital asset escrow method, as recited in claim 29, further comprising the steps of:
generating an account freeze request and collecting a third identity authentication information, and sending said account freeze request and said third identity authentication information to said escrow server, so that said escrow server authenticates an identity of said current user, and when said identity is authenticated, according to said first private key of said first pair of public-private keys, freezes one or more tokens on said second address.

33. The digital asset escrow method, as recited in claim 26, further comprising the steps of:
generating an account reset request and collecting a fourth identity authentication information, and sending said account reset request and said fourth identity authentication information to said escrow server, so that said escrow server authenticates an identity of said current user, and when said identity is authenticated, reallocates said first pair of public-private keys and said second address, wherein one or more tokens on said original second address is transferred to said second address reallocated by said first private key of said original first pair of public-private keys and said corresponding relationship is updated.

34. The digital asset escrow method, as recited in claim 28, further comprising the steps of:
generating an account reset request and collecting a fourth identity authentication information, and sending said account reset request and said fourth identity authentication information to said escrow server, so that said escrow server authenticates an identity of said current user, and when said identity is authenticated, reallocates said first pair of public-private keys and said second address, wherein one or more tokens on said original second address is transferred to said second address reallocated by said first private key of said original first pair of public-private keys and said corresponding relationship is updated.

35. The digital asset escrow method, as recited in claim 29, further comprising the steps of:
generating an account reset request and collecting a fourth identity authentication information, and sending said account reset request and said fourth identity authentication information to said escrow server, so that said escrow server authenticates an identity of said current user, and when said identity is authenticated, reallocates said first pair of public-private keys and said second address, wherein one or more tokens on said original second address is transferred to said second address reallocated by said first private key of said original first pair of public-private keys and said corresponding relationship is updated.

36. The digital asset escrow method, as recited in claim 26, further comprising the steps of:
sending a first transaction group to one or more nodes of said second blockchain, for consensus and execution, wherein said first transaction group comprises a first transaction and a second transaction, wherein said first transaction transfers one or more tokens from said second address to a third address on said second blockchain, and said second transaction transfers one or more tokens from said third address to said second address.

37. The digital asset escrow method, as recited in claim 28, further comprising the steps of:
sending a first transaction group to one or more nodes of said second blockchain, for consensus and execution, wherein said first transaction group comprises a first transaction and a second transaction, wherein said first transaction transfers one or more tokens from said second address to a third address on said second blockchain, and said second transaction transfers one or more tokens from said third address to said second address.

38. The digital asset escrow method, as recited in claim 29, further comprising the steps of:
sending a first transaction group to one or more nodes of said second blockchain, for consensus and execution, wherein said first transaction group comprises a first transaction and a second transaction, wherein said first transaction transfers one or more tokens from said second address to a third address on said second blockchain, and said second transaction transfers one or more tokens from said third address to said second address.

39. The digital asset escrow method, as recited in claim 36, wherein said first transaction group is configured to be executed by multi-signature of transaction parties and said escrow server.
